(19) United States
(12) Patent Application Publication
(10) Pub. No.: US 2006/0074940 A1
(43) Pub. Date: Apr. 6, 2006

(54) Dynamic management of node clusters to enable data sharing

(75) Inventors: David J. Craft, Austin, TX (US); Robert J. Curran, West Hurley, NY (US); Thomas E. Engelsiepen, San Jose, CA (US); Roger L. Haskin, Morgan Hill, CA (US); Frank B. Schmuck, Campbell, CA (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/958,927

(22) Filed: Oct. 5, 2004

(51) Int. Cl. G06F 7/00

(52) U.S. Cl. 707/100

(57) ABSTRACT

An active cluster is dynamically formed to perform a specific task. The active cluster includes one or more data owning nodes of at least one data owning cluster and one or more data using nodes of at least one data using cluster that are to access data of the data owning cluster. The active cluster is dynamic in that the nodes of the cluster are not statically defined. Instead, the active cluster is formed, when a need for such a cluster arises to satisfy a particular task.

### TECHNICAL FIELD

This invention relates, in general, to data sharing in a communications environment, and in particular, to dynamically managing one or more clusters of nodes to enable the sharing of data.

### BACKGROUND OF THE INVENTION

Clustering is used for various purposes, including parallel processing, load balancing and fault tolerance. Clustering includes the grouping of a plurality of nodes, which share resources and collaborate with each other to perform various tasks, into one or more clusters. A cluster may include any number of nodes.

Advances in technology have affected the size of clusters. For example, the evolution of storage area networks (SANs) has produced clusters with large numbers of nodes. Each of these clusters has a fixed known set of nodes with known network addressability. Each of these clusters has a common system management, common user domains and other characteristics resulting from the static environment.

The larger the cluster, typically, the more difficult it is to manage. This is particularly true when a cluster is created as a super-cluster that includes multiple sets of resources. This super-cluster is managed as a single large cluster of thousands of nodes. Not only is management of such a cluster difficult, such centralized management may not meet the needs of one or more sets of nodes within the super-cluster.

Thus, a need exists for a capability that facilitates management of clusters. As one example, a need exists for a capability that enables creation of a cluster and the dynamic joining of nodes to that cluster to perform a specific task.

### SUMMARY OF THE INVENTION

The shortcomings of the prior art are overcome and additional advantages are provided through the provision of a method of managing clusters of a communications environment. The method includes, for instance, obtaining a cluster of nodes, the cluster of nodes comprising one or more nodes of a data owning cluster; and dynamically joining the cluster of nodes by one or more other nodes to access data owned by the data owning cluster.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a cluster configuration, in accordance with an aspect of the present invention;

FIG. 2 depicts one example of an alternate cluster configuration, in accordance with an aspect of the present invention;

FIG. 3 depicts one example of the coupling of a plurality of clusters, in accordance with an aspect of the present invention;

FIG. 4 depicts yet another example of the coupling of a plurality of clusters, in accordance with an aspect of the present invention;

FIG. 5 depicts one example of active clusters being formed from nodes of various clusters, in accordance with an aspect of the present invention;

FIG. 6 depicts one example of clusters being coupled to a compute pool, in accordance with an aspect of the present invention;

FIG. 7 depicts one example of active clusters being formed using the nodes of the compute pool, in accordance with an aspect of the present invention;

FIG. 8 depicts one embodiment of the logic associated with installing a data owning cluster, in accordance with an aspect of the present invention;

FIG. 9 depicts one embodiment of the logic associated with installing a data using cluster, in accordance with an aspect of the present invention;

FIG. 10 depicts one embodiment of the logic associated with processing a request for data, in accordance with an aspect of the present invention;

FIG. 11 depicts one embodiment of logic associated with determining whether a user is authorized to access data, in accordance with an aspect of the present invention;

FIG. 12 depicts one embodiment of the logic associated with a data using node mounting a file system of a data owning cluster, in accordance with an aspect of the present invention;

FIG. 13 depicts one embodiment of the logic associated with mount processing being performed by a file system manager, in accordance with an aspect of the present invention;

FIG. 14 depicts one embodiment of the logic associated with maintaining a lease associated with a storage medium of a file system, in accordance with an aspect of the present invention; and

FIG. 15 depicts one embodiment of the logic associated with leaving an active cluster, in accordance with an aspect of the present invention.

### BEST MODE FOR CARRYING OUT THE INVENTION

In accordance with an aspect of the present invention, clusters are dynamically provided to enable data access. As one example, an active cluster is formed, which includes one or more nodes from at least one data owning cluster and one or more nodes from at least one data using cluster. A node of a data using cluster dynamically joins the active cluster, in response to, for instance, a request by the node for data owned by a data owning cluster. A successful join enables the data using node to access data of the data owning cluster, assuming proper authorization.

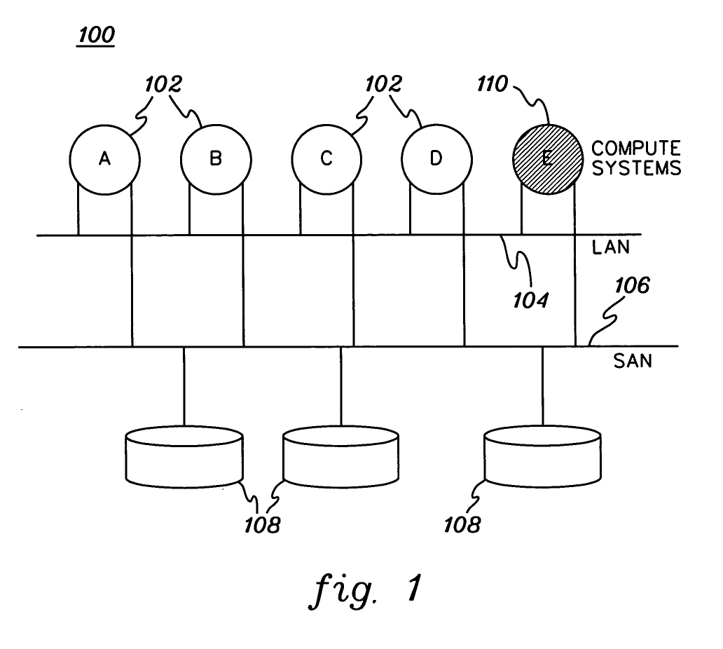

One example of a cluster configuration is depicted in FIG. 1. A cluster configuration 100 includes a plurality of nodes 102, such as, for instance, machines, compute nodes, compute systems or other communications nodes. In one specific example, node 102 includes an RS/6000 running an AIX or Linux operating system, offered by International Business Machines Corporation, Armonk, N.Y. The nodes are coupled to one another via a network, such as a local area network (LAN) 104 or another network in other embodiments.

Nodes 102 are also coupled to a storage area network (SAN) 106, which further couples the nodes to one or more storage media 108. The storage media includes, for instance, disks or other types of storage media. The storage media include files having data to be accessed. A collection of files is referred to herein as a file system, and there may be one or more file systems in a given cluster.

A file system is managed by a file system manager node 110, which is one of the nodes of the cluster. The same file system manager can manage one or more of the file systems of the cluster or each file system may have its own file system manager or any combination thereof. Also, in a further embodiment more than one file system manager may be selected to manage a particular file system.

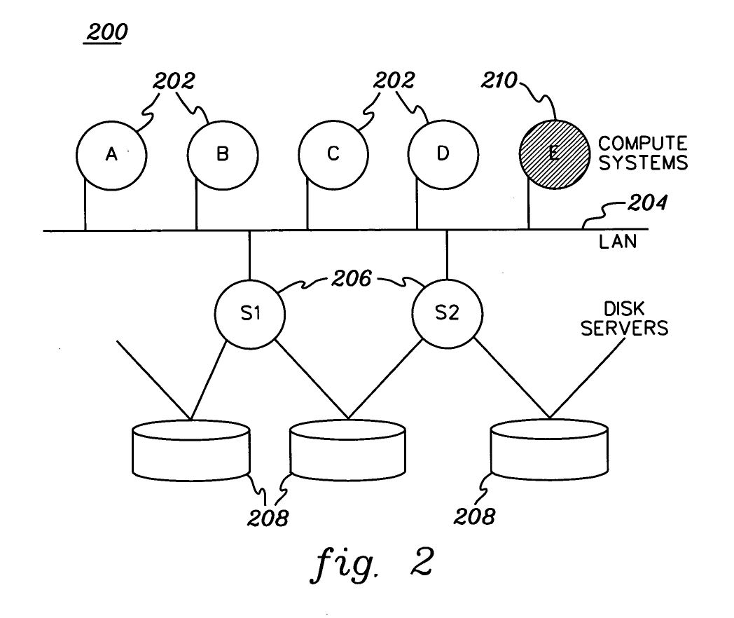

An alternate cluster configuration is depicted in FIG. 2. In this example, a cluster configuration 200 includes a plurality of nodes 202 which are coupled to one another via a local area network 204. The local area network 204 couples nodes 202 to a plurality of servers 206. Servers 206 have a physical connection to one or more storage media 208. Similar to FIG. 1, a node 210 is selected as the file system manager.

The data flow between the server nodes and the communications nodes is the same as addressing the storage media directly, although the performance and/or syntax may be different. As examples, the data flow of FIG. 2 has been implemented by International Business Machines Corporation on the Virtual Shared Disk facility for AIX and the Network Shared Disk facility for AIX and Linux. The Virtual Shared Disk facility is described in, for instance, “GPFS: A Shared-Disk File System For Large Computing Clusters,” Frank Schmuck and Roger Haskin, Proceedings of the Conference on File and Storage Technologies (FAST '02), 28-30 Jan. 2002, Monterey, Calif., pp 231-244 (USENIX, Berkeley, Calif.); and the Network Shared Disk facility is described in, for instance, “An Introduction to GPFS v1.3 for Linux-White Paper” (June 2003), available from International Business Machines Corporation (www-1.ibm.com/servers/eserver/clusters/whitepapers/gpfs_linux_intro.pdf), each of which is hereby incorporated herein by reference in its entirety.

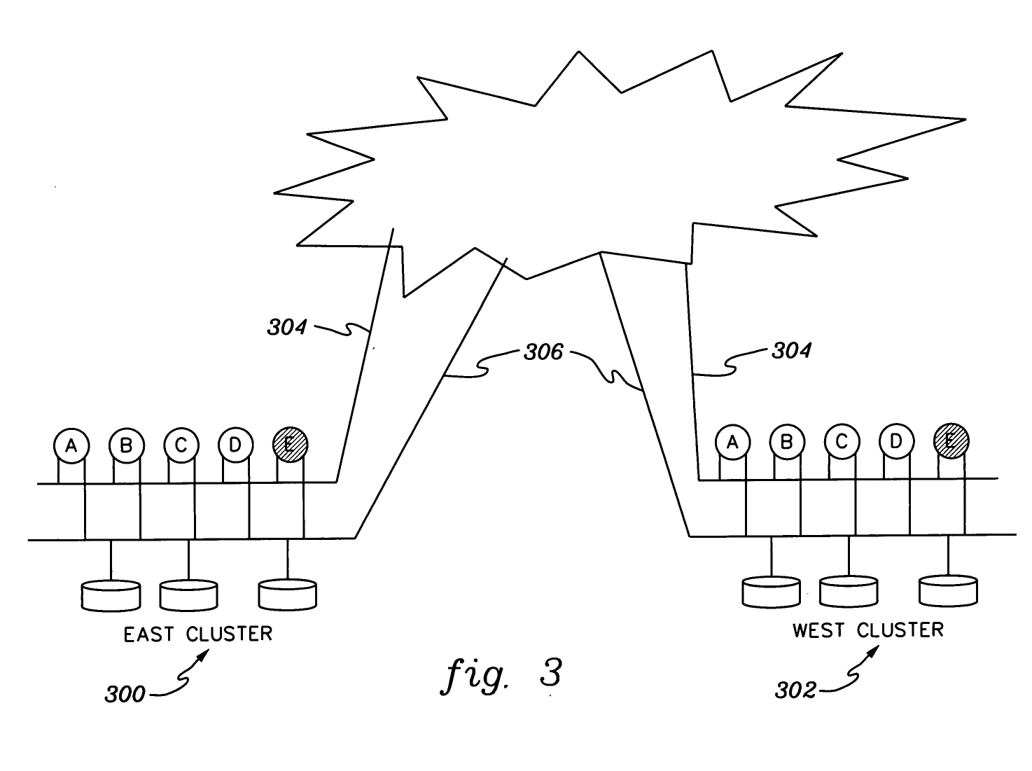

In accordance with an aspect of the present invention, one cluster may be coupled to one or more other clusters, while still maintaining separate administrative and operational domains for each cluster. For instance, as depicted in FIG. 3, one cluster 300, referred to herein as an East cluster, is coupled to another cluster 302, referred to herein as a West cluster. Each of the clusters has data that is local to that cluster, as well as a control path 304 and a data network path 306 to the other cluster. These paths are potentially between geographically separate locations. Although separate data and control network connections are shown, this is only one embodiment. Either a direct connection into the data network or a combined data/storage network with storage servers similar to FIG. 2 is also possible. Many other variations are also possible.

Each of the clusters is maintained separately allowing individual administrative policies to prevail within a particular cluster. This is in contrast to merging the clusters, and thus, the resources of the clusters, creating a single administrative and operational domain. The separate clusters facilitate management and provide greater flexibility.

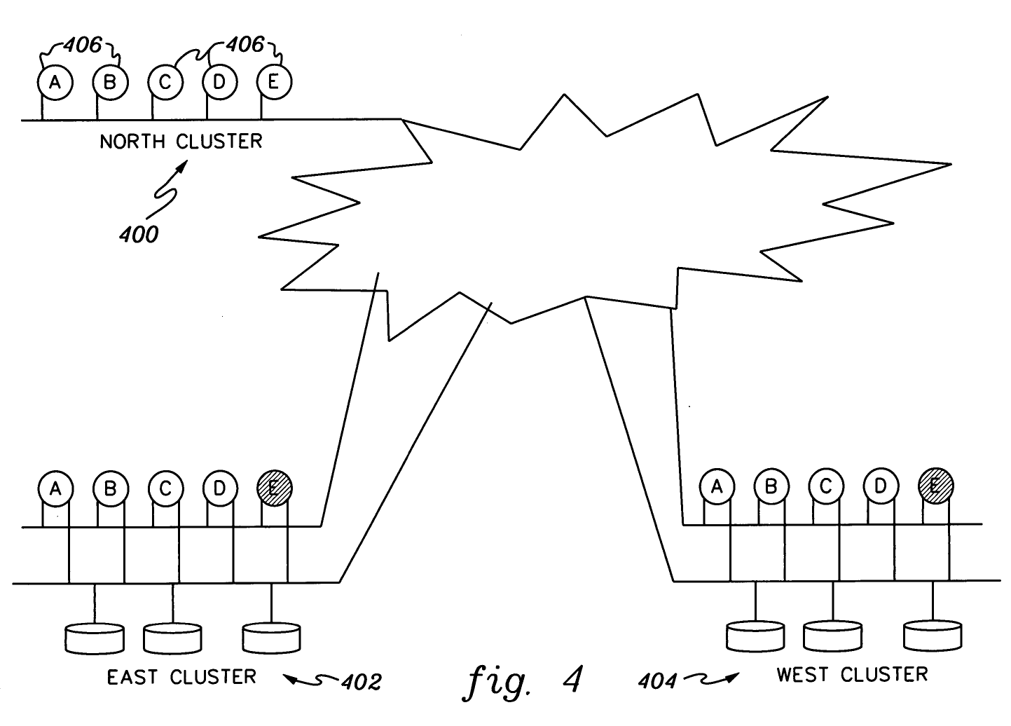

Additional clusters may also be coupled to one another, as depicted in FIG. 4. As shown, a North cluster 400 is coupled to East cluster 402 and West cluster 404. The North cluster, in this example, is not a home cluster to any file system. That is, it does not own any data. Instead, it is a collection of nodes 406 that can mount file systems from the East or West clusters or both clusters concurrently, in accordance with an aspect of the present invention.

Although in each of the clusters described above five nodes are depicted, this is only one example. Each cluster may include one or more nodes and each cluster may have a different number or the same number of nodes as another cluster.

In accordance with an aspect of the present invention, a cluster may be at least one of a data owning cluster, a data using cluster and an active cluster. A data owning cluster is a collection of nodes, which are typically, but not necessarily, co-located with the storage used for at least one file system owned by the cluster. The data owning cluster controls access to the one or more file systems, performs management functions on the file system(s), controls the locking of the objects which comprise the file system(s) and/or is responsible for a number of other central functions.

The data owning cluster is a collection of nodes that share data and have a common management scheme. As one example, the data owning cluster is built out of the nodes of a storage area network, which provides a mechanism for connecting multiple nodes to the same storage media and providing management software therefor.

As one example, a file system owned by the data owning cluster is implemented as a SAN file system, such as a General Parallel File System (GPFS), offered by International Business Machines Corporation, Armonk, N.Y. GPFS is described in, for instance, “GPFS: A Parallel File System,” IBM Publication No. SG24-5165-00 (May 7, 1998), which is hereby incorporated herein by reference in its entirety.

Applications can run on the data owning clusters. Further, the user id space of the owning cluster is the user id space that is native to the file system and stored within the file system.

A data using cluster is a set of one or more nodes which desires access to data owned by one or more data owning clusters. The data using cluster runs applications that use data available from one or more owning clusters. The data using cluster has configuration data available to it directly or through external directory services. This data includes, for instance, a list of file systems which might be available to the nodes of the cluster, a list of contact points within the owning cluster to contact for access to the file systems, and a set of credentials which allow access to the data. In particular, the data using cluster is configured with sufficient information to start the file system code and a way of determining the contact point for each file system that might be desired. The contact points may be defined using an external directory service or be included in a list within a local file system of each node. The data using cluster is also configured with security credentials which allow each node to identify itself to the data owning clusters.

An active cluster includes one or more nodes from at least one data owning cluster, in addition to one or more nodes from at least one data using cluster that have registered with the data owning cluster. For example, the active cluster includes nodes (and related resources) that have data to be shared and those nodes registered to share data of the cluster.

A node of a data using cluster can be part of multiple active clusters and a cluster can concurrently be a data owning cluster for a file system and a data using cluster for other file systems. Just as a data using cluster may access data from multiple data owning clusters, a data owning cluster may serve multiple data using clusters. This allows dynamic creation of active clusters to perform a job using the compute resources of multiple data using clusters. The job scheduling facility selects nodes, from a larger pool, which will cooperate in running the job. The capability of the assigned jobs to force the node to join the active cluster for the required data using the best available path to the data provides a highly flexible tool in running large data centers.

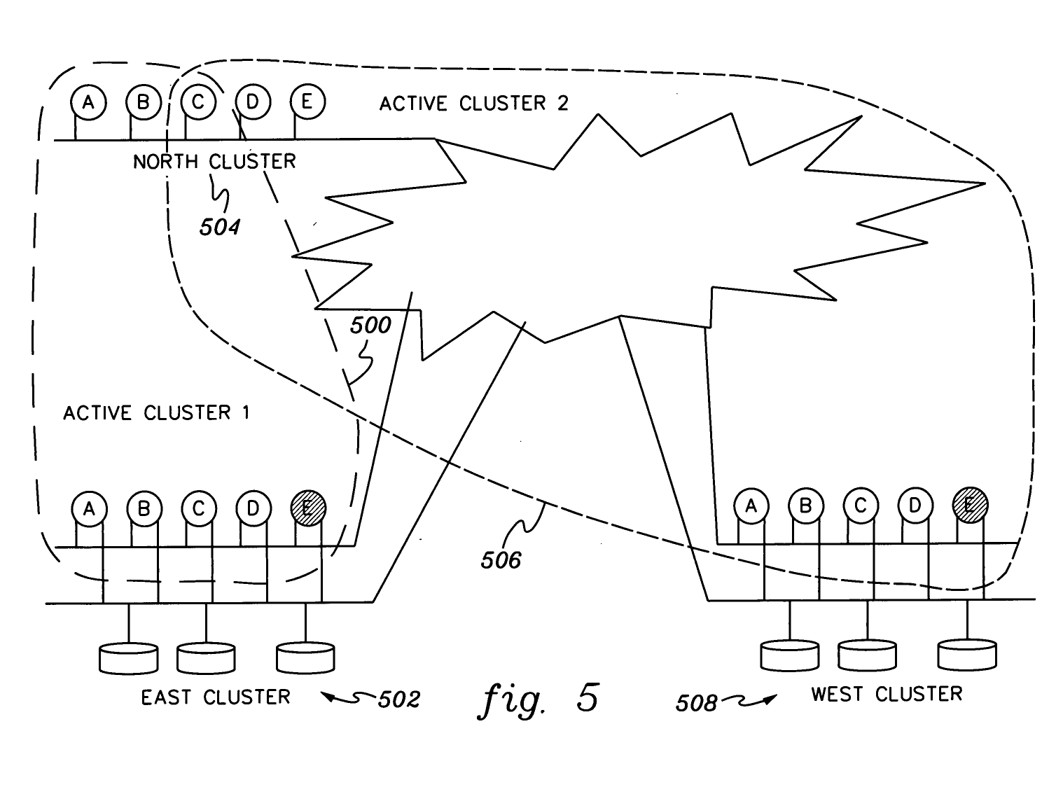

Examples of active clusters are depicted in FIG. 5. In accordance with an aspect of the present invention, an active cluster for the purpose of accomplishing work is dynamically created. In this example, two active clusters are shown. An Active Cluster 1 (500) includes a plurality of nodes from East cluster 502 and a plurality of nodes from North cluster 504. East cluster 502 includes a fixed set of nodes controlling one or more file systems. These nodes have been joined, in this example, by a plurality of data using nodes of North Cluster 504, thereby forming Active Cluster 1. Active Cluster 1 includes the nodes accessing the file systems owned by East Cluster.

Similarly, an Active Cluster 2 (506) includes a plurality of nodes from West cluster 508 that control one or more file systems and a plurality of data using nodes from North cluster 504. Node C of North Cluster 504 is part of Active Cluster 1, as well as Active Cluster 2. Although in these examples, all of the nodes of West Cluster and East Cluster are included in their respective active clusters, in other examples, less than all of the nodes are included.

The nodes which are part of a non-data owning cluster are in an active cluster for the purpose of doing specific work at this point in time. North nodes A and B could be in Active Cluster 2 at a different point in time doing different work. Note that West nodes could join Active Cluster 1 also if the compute requirements include access to data on the East cluster. Many other variations are possible.

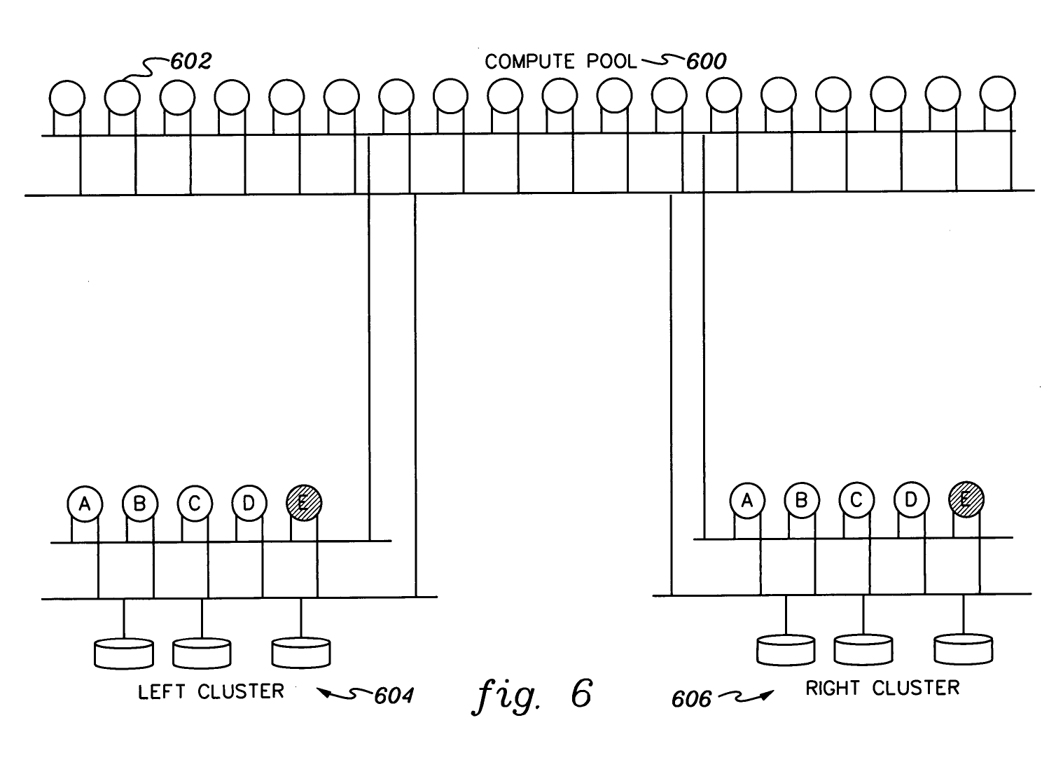

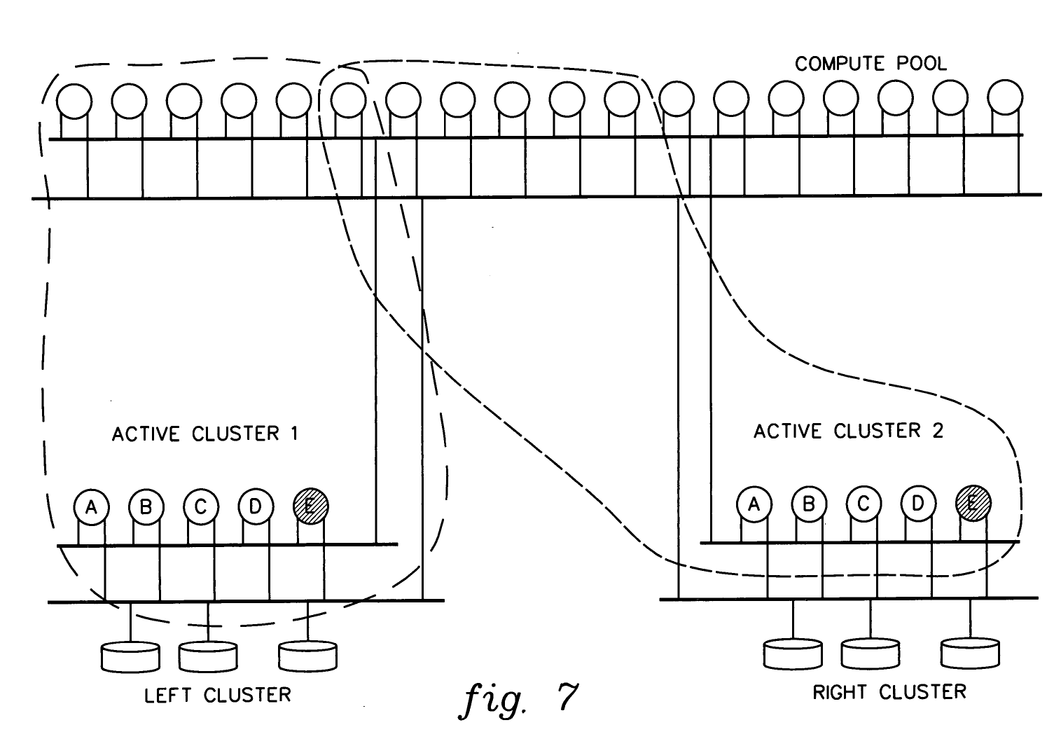

In yet another configuration, a compute pool 600 (FIG. 6) includes a plurality of nodes 602 which have potential connectivity to one or more data owning clusters 604, 606. In this example, the compute pool exists primarily for the purpose of forming active clusters, examples of which are depicted in FIG. 7.

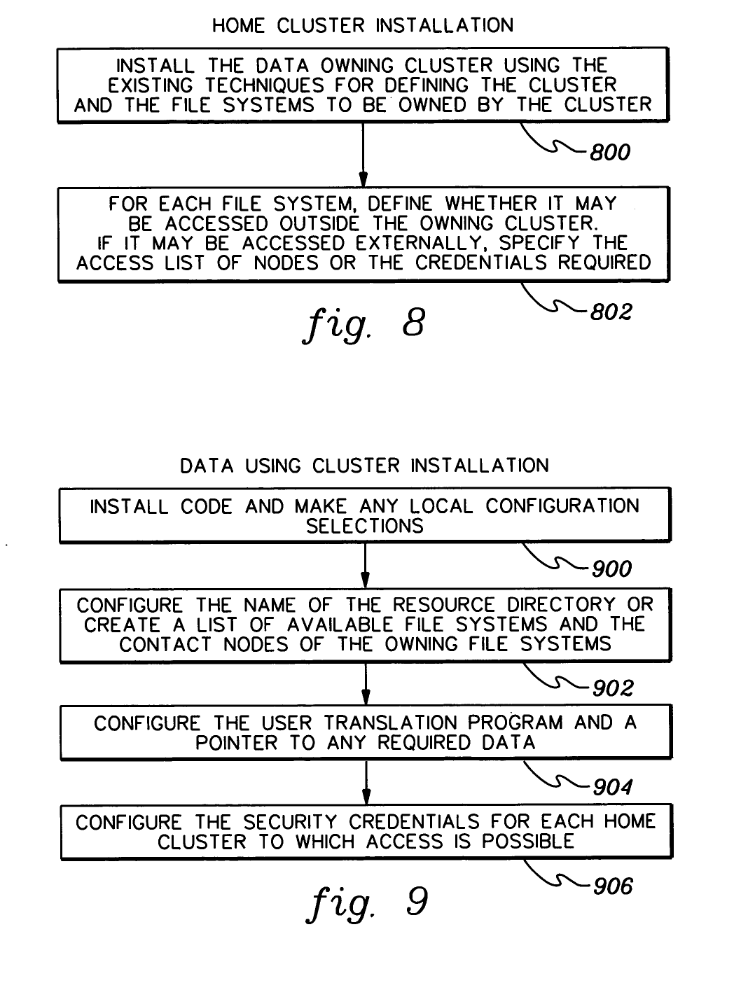

In order to form active clusters, the data owning and data using clusters are to be configured. Details associated with configuring such clusters are described with reference to FIGS. 8 and 9. Specifically, one example of the configuration of a data owning cluster is described with reference to FIG. 8, and one example of the configuration of a data using cluster is described with reference to FIG. 9.

Referring to FIG. 8, a data owning cluster is installed using known techniques, STEP 800. For example, a static configuration is defined in which a cluster is named and the nodes to be associated with that cluster are specified. This may be a manual process or an automated process. One example of creating a cluster is described in U.S. Pat. No. 6,725,261 entitled “Method, System And Program Products For Automatically Configuring Clusters Of A Computing Environment,” Novaes et al., issued Apr. 20, 2004, which is hereby incorporated herein by reference in its entirety. Many other embodiments also exist and can be used to create the data owning clusters.

Further, in this example, one or more file systems to be owned by the cluster are also installed. These file systems include the data to be shared by the nodes of the various clusters. In one example, the file systems are the General Parallel File Systems (GPFS), offered by International Business Machines Corporation. One or more aspects of GPFS are described in “GPFS: A Parallel File System,” IBM Publication No. SG24-5165-00 (May 7, 1998), which is hereby incorporated herein by reference in its entirety, and in various patents/publications, including, but not limited to, U.S. Pat. No. 6,708,175 entitled “Program Support For Disk Fencing In A Shared Disk Parallel File System Across Storage Area Network,” Curran et al., issued Mar. 16, 2004; U.S. Pat. No. 6,032,216 entitled “Parallel File System With Method Using Tokens For Locking Modes,” Schmuck et al., issued Feb. 29, 2000; U.S. Pat. No. 6,023,706 entitled “Parallel File System And Method For Multiple Node File Access,” Schmuck et al, issued Feb. 8, 2000; U.S. Pat. No. 6,021,508 entitled “Parallel File System And Method For Independent Metadata Loggin,” Schmuck et al., issued Feb. 1, 2000; U.S. Pat. No. 5,999,976 entitled “Parallel File System And Method With Byte Range API Locking,” Schmuck et al., issued Dec. 7, 1999; U.S. Pat. No. 5,987,477 entitled “Parallel File System And Method For Parallel Write Sharing,” Schmuck et al., issued Nov. 16, 1999; U.S. Pat. No. 5,974,424 entitled “Parallel File System And Method With A Metadata Node,” Schmuck et al., issued Oct. 26, 1999; U.S. Pat. No. 5,963,963 entitled “Parallel File System And Buffer Management Arbitration,” Schmuck et al., issued Oct. 5, 1999; U.S. Pat. No. 5,960,446 entitled “Parallel File System And Method With Allocation Map,” Schmuck et al., issued Sep. 28, 1999; U.S. Pat. No. 5,950,199 entitled “Parallel File System And Method For Granting Byte Range Tokens,” Schmuck et al., issued Sep. 7, 1999; U.S. Pat. No. 5,946,686 entitled “Parallel File System And Method With Quota Allocation,” Schmuck et al., issued Aug. 31, 1999; U.S. Pat. No. 5,940,838 entitled “Parallel File System And Method Anticipating Cache Usage Patterns,” Schmuck et al., issued Aug. 17, 1999; U.S. Pat. No. 5,893,086 entitled “Parallel File System And Method With Extensible Hashing,” Schmuck et al., issued Apr. 6, 1999; U.S. Patent Application Publication No. 20030221124 entitled “File Level Security For A Metadata Controller In A Storage Area Network,” Curran et al., published Nov. 27, 2003; U.S. Patent Application Publication No. 20030220974 entitled “Parallel Metadata Service In Storage Area Network Environment,” Curran et al., published Nov. 27, 2003; U.S. Patent Application Publication No. 20030018785 entitled “Distributed Locking Protocol With Asynchronous Token Prefetch And Relinquish,” Eshel et al., published Jan. 23, 2003; U.S. Patent Application Publication No. 20030018782 entitled “Scalable Memory Management Of Token State For Distributed Lock Managers,” Dixon et al., published Jan. 23, 2003; and U.S. Patent Application Publication No. 20020188590 entitled “Program Support For Disk Fencing In A Shared Disk Parallel File System Across Storage Area Network,” Curran et al., published Dec. 12, 2002, each of which is hereby incorporated herein by reference in its entirety.

Although the use of file systems is described herein, in other embodiments, the data to be shared need not be maintained as file systems. Instead, the data may merely be stored on the storage media or stored as a structure other than a file system.

Subsequent to installing the data owning cluster and file systems, the data owning cluster, also referred to as the home cluster, is configured with authorization and access controls for nodes wishing to join an active cluster for which the data owning cluster is a part, STEP 802. For example, for each file system, a definition is provided specifying whether the file system may be accessed outside the owning cluster. If it may be accessed externally, then an access list of nodes or a set of required credentials is specified. As one example, a pluggable security infrastructure is implemented using a public key authentication. Other security mechanisms can also be plugged. This concludes installation of the data owning cluster.

One embodiment of the logic associated with installing a data using cluster is described with reference to FIG. 9. This installation includes configuring the data using cluster with the file systems that it may need to mount and either the contact nodes for each file system or a directory server that maintains those contact points. It is also configured with the credentials to be used when mounting each file system. Further, it is configured with a user id mapping program which maps users at the using location to a user id at the owning location.

Initially, file system code is installed and local configuration selections are made, STEP 900. For instance, there are various parameters that pertain to network and memory configuration which are used to install the data using cluster before it accesses data. The file system code is installed by, for instance, an administrator using the native facilities of the operating system. For example, rpm on Linux is used. Certain parameters which apply to the local node are specified. These parameters include, for instance, which networks are available, what memory can be allocated and perhaps others.

Thereafter, a list of available file systems and contact nodes of the owning file systems is created or the name of a resource directory is configured, STEP 902. In particular, there are, for instance, two ways of finding the file system resources that are applicable to the data using cluster: either by, for instance, a system administrator explicitly configuring the list of available file systems and where to find them, or by creating a directory at a known place, which may be accessed by presenting the name of the file system that the application is requesting and receiving back a contact point for it. The list includes, for instance, a name of the file system, the cluster that contains that file system, and one or more contact points for the cluster.

In addition to the above, a user translation program is configured, STEP 904. For instance, the user translation program is identified by, for example, a system administrator (e.g., a pointer to the program is provided). The translation program translates a local user id to a user id of the data owning cluster. This is described in further detail below. In another embodiment, a translation is not performed, since a user's identity is consistent everywhere.

Additionally, security credentials are configured by, for instance, a system administrator, for each data owning (or home) cluster to which access is possible, STEP 906. Security credentials may include the providing of a key. Further, each network has its own set of rules as to whether security is permissible or not. However, ultimately the question resolves to: prove that I am who I say I am or trust that I am who I say I am.

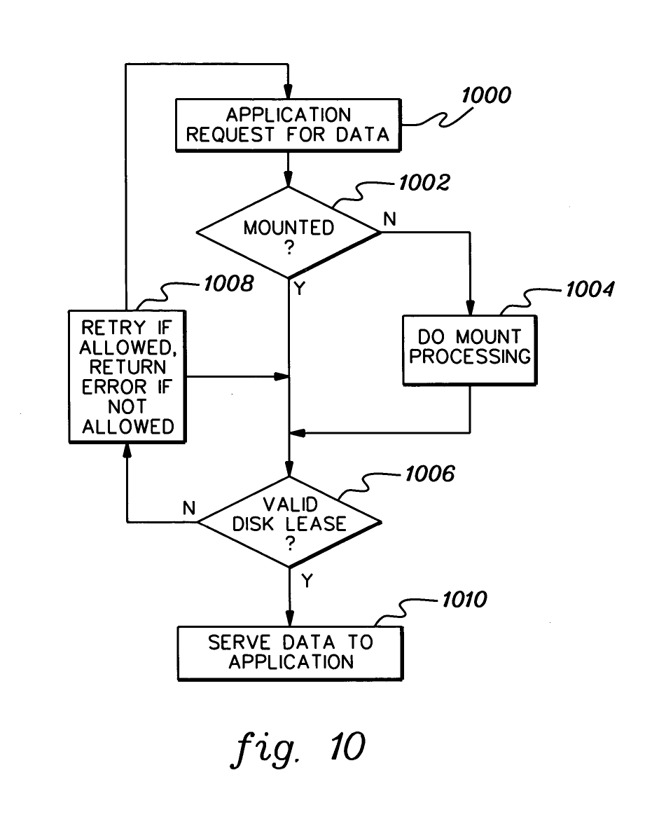

Subsequent to installing the one or more data owning clusters and the one or more data using clusters, those clusters may be used to access data. One embodiment of the logic associated with accessing data is described with reference to FIG. 10. A request for data is made by an application that is executing on a data using node, STEP 1000. The request is made by, for instance, identifying a desired file name. In response to the request for data, a determination is made as to whether the file system having the requested file has been mounted, INQUIRY 1002. In one example, this determination is made locally by checking a local state variable that is set when a mount is complete. The local state includes the information collected at mount time. If the file system is not mounted, then mount processing is performed, STEP 1004, as described below.

After mount processing or if the file system has previously been mounted, then a further determination is made as to whether the lease for the storage medium (e.g., disk) having the desired file is valid, INQUIRY 1006. That is, access to the data is controlled by establishing leases for the various storage media storing the data to be accessed. Each lease has an expiration parameter (e.g., date and/or time) associated therewith, which is stored in memory of the data using node. To determine whether the lease is valid, the data using node checks the expiration parameter. Should the lease be invalid, then a retry is performed, if allowed, or an error is presented, if not allowed, STEP 1008. On the other hand, if the lease is valid, then the data is served to the application, assuming the user of the application is authorized to receive the data, STEP 1010.

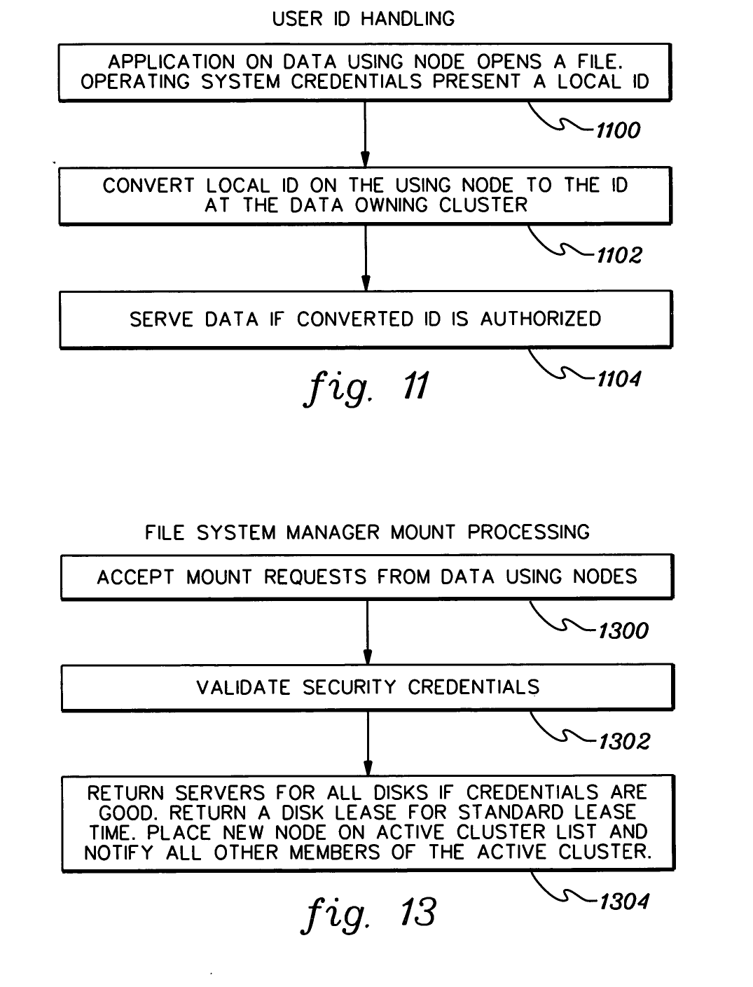

Authorization of the user includes translating the user identifier of the request from the data using node to a corresponding user identifier at the data owning cluster, and then checking authorization of that translated user identifier. One embodiment of the logic associated with performing the authorization is described with reference to FIG. 11.

Initially, an application on the data using node opens a file and the operating system credentials present a local user identifier, STEP 1100. The local identifier on the using node is converted to the identifier at the data owning cluster, STEP 1102. As one example, a translation program executing on the data using node is used to make the conversion. The program includes logic that accesses a table to convert the local identifier to the user identifier at the owning cluster.

One example of a conversion table is depicted below:

| User ID at | User ID at | User Name at | User Name at |
|---|---|---|---|
| using cluster | owning cluster | using cluster | owning cluster |
| 1234 | 4321 | joe | Jsmith |
| 8765 | 5678 | sally | Sjones |

The table is created by a system administrator, in one example, and includes various columns, including, for instance, a user identifier at the using cluster and a user identifier at the owning cluster, as well as a user name at the using cluster and a user name at the owning cluster. Typically, it is the user name that is provided, which is then associated with a user id. As one example, a program invoked by Sally on a node in the data using cluster creates a file. If the file is created in local storage, then it is assigned to be owned by user id 8765 representing Sally. However, if the file is created in shared storage, it is created using user id 5678 representing Sjones. If Sally tries to access an existing file, the file system is presented user id 8765. The file system invokes the conversion program and is provided with id 5678.

Subsequent to converting the local identifier to the identifier at the data owning cluster, a determination is made as to whether the converted identifier is authorized to access the data, STEP 1104. This determination may be made in many ways, including by checking an authorization table or other data structure. If the user is authorized, then the data is served to the requesting application.

Data access can be performed by direct paths to the data (e.g., via a storage area network (SAN), a SAN enhanced with a network connection, or a software simulation of a SAN using, for instance, Virtual Shared Disk, offered by International Business Machines Corporation); or by using a server node, if the node does not have an explicit path to the storage media, as examples. In the latter, the server node provides a path to the storage media.

During the data service, the file system code of the data using node reads from and/or writes to the storage media directly after obtaining appropriate locks. The file system code local to the application enforces authorization by translating the user id presented by the application to a user id in the user space of the owning cluster, as described herein. Further details regarding data flow and obtaining locks are described in the above-referenced patents/publications, each of which is hereby incorporated herein by reference in its entirety.

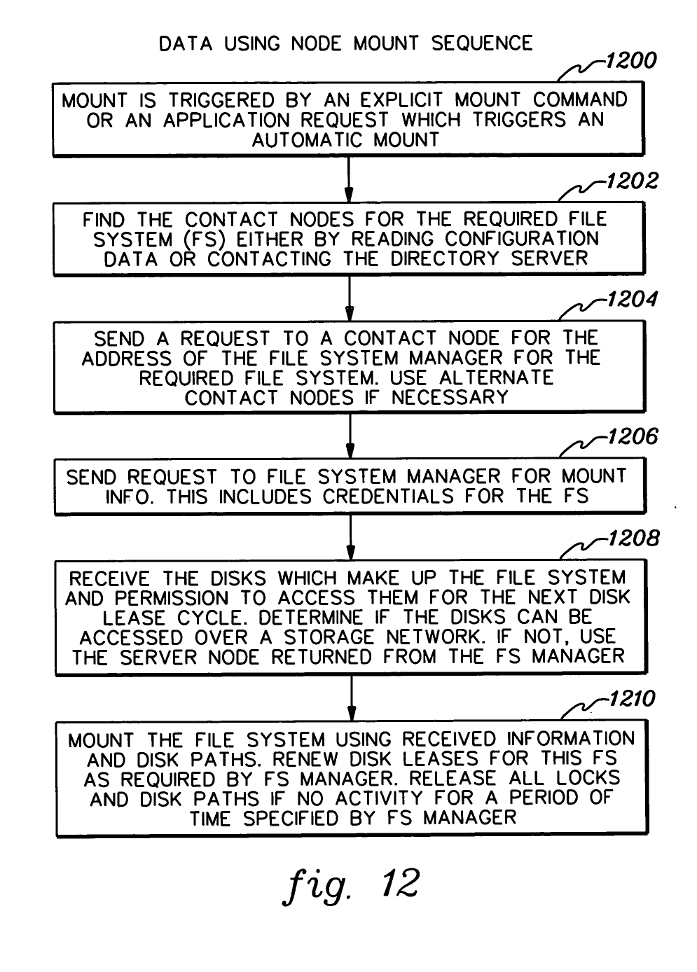

As described above, in order to access the data, the file system that includes the data is to be mounted. One embodiment of the logic associated with mounting the file system is described with reference to FIG. 12.

Referring to FIG. 12, initially a mount is triggered by an explicit mount command or by a user accessing a file system, which is set up to be automounted, STEP 1200. In response to triggering the mount, one or more contact nodes for the desired file system is found, STEP 1202. The contact nodes are nodes set up by the owning cluster as contact nodes and are used by a data using cluster to access a data owning cluster, and in particular, one or more file systems of the data owning cluster. Any node in the owning cluster can be a contact node. The contact nodes can be found by reading local configuration data that includes this information or by contacting a directory server.

Subsequent to determining the contact nodes, a request is sent to a contact node requesting the address of the file system manager for the desired file system, STEP 1204. If the particular contact node for which the request is sent does not respond, an alternate contact node may be used. By definition, a contact node that responds knows how to access the file system manager.

In response to receiving a reply from the contact node with the identity of the file system manager, a request is sent to the file system manager requesting mount information, STEP 1206. The request includes any required security credentials, and the information sought includes the details the data using node needs to access the data. For instance, it includes a list of the storage media (e.g., disks) that make up the file system and the rules that are used in order to access the file system. As one example, a rule includes: for this kind of file system, permission to access the file system is to be sought every X amount of time. Many other rules may also be used.

Further details regarding the logic associated with the file system manager processing the mount request are described with reference to FIG. 13. This processing assumes that the file system manager is remote from the data using node providing the request. In another embodiment in which the file system manager is local to the data using node, one or more of the following steps, such as security validation, may not need to take place.

In one embodiment, the file system manager accepts mount requests from a data using node, STEP 1300. In response to receiving the request, the file system manager takes the security credentials from the request and validates the security credentials of the data using node, STEP 1302. This validation may include public key authentication, checking a validation data structure (e.g., table), or other types of security validation. If the credentials are approved, the file system manager returns to the data using node a list of one or more servers for the needed or desired storage media, STEP 1304. It also returns, in this example, for each storage medium, a lease for standard lease time. Additionally, the file system manager places the new data using node on the active cluster list and notifies other members of the active cluster of the new node.

Returning to FIG. 12, the data using node receives the list of storage media that make up the file system and permission to access them for the next lease cycle, STEP 1208. A determination is made as to whether the storage medium can be accessed over a storage network. If not, then the server node returned from the file system manager is used to access the media.

The data using node mounts the file system using received information and disk paths, allowing access by the data using node to data owned by the data owning cluster, STEP 1210. As an example, a mount includes reading each disk in the file system to insure that the disk descriptions on the disks match those expected for this file system, in addition to setting up the local data structures to translate user file requests to disk blocks on the storage media. Further, the leases for the file system are renewed as indicated by the file system manager. Additionally, locks and disk paths are released, if no activity for a period of time specified by the file system manager is met.

Subsequent to successfully mounting the file system on the data using node, a heart beating protocol, referred to as a storage medium (e.g., disk) lease, is begun. The data using node requests permission to access the file system for a period of time and is to renew that lease prior to its expiration. If the lease expires, no further I/O is initiated. Additionally, if no activity occurs for a period of time, the using node puts the file system into a locally suspended state releasing the resources held for the mount both locally and on the data owning cluster. Another mount protocol is executed, if activity resumes.

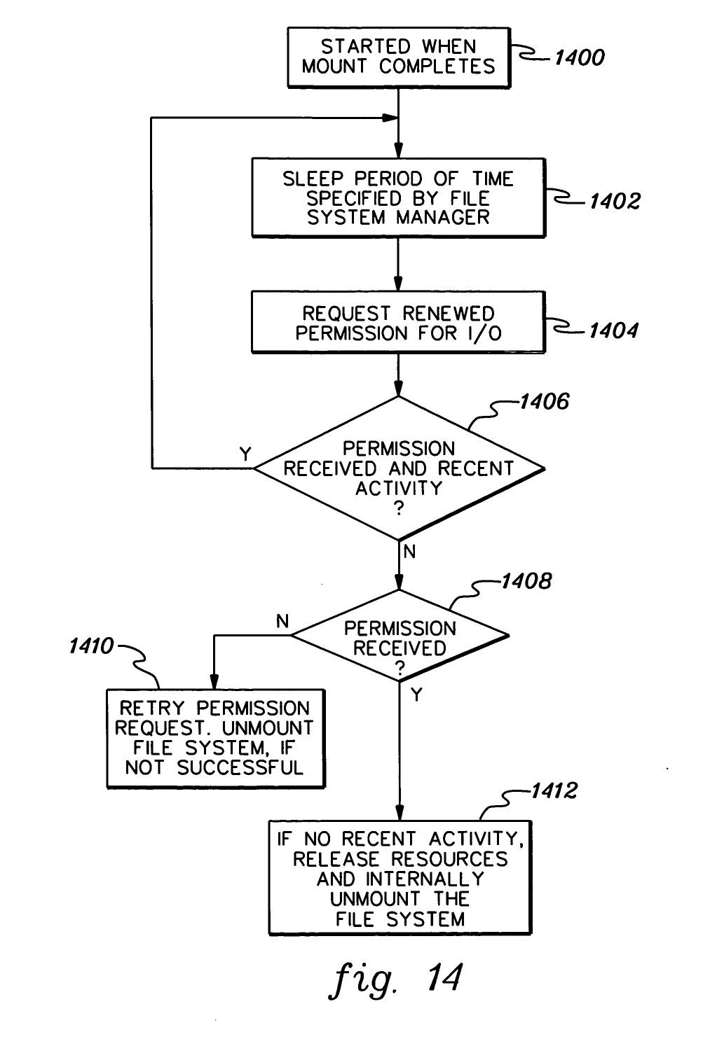

One example of maintaining a lease is described with reference to FIG. 14. In one embodiment, this logic starts when the mount completes, STEP 1400. Initially, a sleep period of time (e.g., 5 seconds) is specified by the file system manager, STEP 1402. In response to the sleep period of time expiring, the data using node requests renewal of the lease, STEP 1404. If permission is received and there is recent activity with the file system manager, INQUIRY 1406, then processing continues with STEP 1402. Otherwise, processing continues with determining whether permission is received, INQUIRY 1408. If permission is not received, then the permission request is retried and an unmount of the file system is performed, if the retry is unsuccessful, STEP 1410. On the other hand, if the permission is received, and there has been no recent activity with the file system manager, then resources are released and the file system is internally unmounted, STEP 1412. The file system is to be active to justify devoting resources to maintain the mount. Thus, if no activity occurs for a period of time, the mount is placed in a suspended state and a full remount protocol is used with the server to re-establish the mount as capable of serving data. This differs from losing the disk lease in that no error had occurred and the internal unmount is not externally visible.

Further details regarding disk leasing are described in U.S. patent application Ser. No. 10/154,009 entitled “Parallel Metadata Service In Storage Area Network Environment,” Curran et al., filed May 23, 2002, and U.S. Pat. No. 6,708,175 entitled “Program Support For Disk Fencing In A Shared Disk Parallel File System Across Storage Area Network,” Curran et al., issued Mar. 16, 2004, each of which is hereby incorporated herein by reference in its entirety.

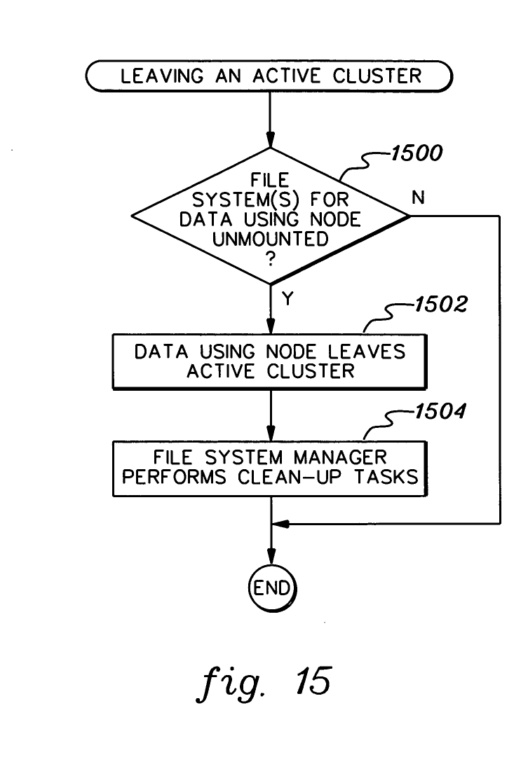

In accordance with an aspect of the present invention, if all of the file systems used by a data using node are unmounted, INQUIRY 1500 (FIG. 15), then the data using node automatically leaves the active cluster, STEP 1502. This includes, for instance, removing the node from the active cluster list and notifying the other members of the active cluster of the leaving, STEP 1504. As one example, the above tasks are performed by the file system manager of the last file system to be unmounted for this data using node.

Described in detail above is a capability in which one or more nodes of a data using cluster may dynamically join one or more nodes of a data owning cluster for the purposes of accessing data. By registering the data using cluster (at least a portion thereof) with the data owning cluster (at least a portion thereof), an active cluster is formed. A node of a data using cluster may access data from multiple data owning clusters. Further, a data owning cluster may serve multiple data using clusters. This allows dynamic creation of active clusters to perform a job using the compute resources of multiple data using clusters.

In accordance with an aspect of the present invention, nodes of one cluster can directly access data (e.g., without copying the data) of another cluster, even if the clusters are geographically distant (e.g., even in other countries).

Advantageously, one or more capabilities of the present invention enable the separation of data using clusters and data owning clusters; allow administration and policies the ability to have the data using cluster be part of multiple clusters; provide the ability to dynamically join an active cluster and leave that cluster when active use of the data is no longer desired; and provide the ability of the node which has joined the active cluster to participate in the management of metadata.

A node of the data using cluster may access multiple file systems for multiple locations by simply contacting the data owning cluster for each file system desired. The data using cluster node provides appropriate credentials to the multiple file systems and maintains multiple storage media leases. In this way, it is possible for a job running at location A to use data, which resides at locations B and C, as examples.

As used herein, a node is a machine; device; computing unit; computing system; a plurality of machines, computing units, etc. coupled to one another; or anything else that can be a member of a cluster. A cluster of nodes includes one or more nodes. The obtaining of a cluster includes, but is not limited to, having a cluster, receiving a cluster, providing a cluster, forming a cluster, etc.

Further, the owning of data refers to owning the data, one or more paths to the data, or any combination thereof. The data can be stored locally or on any type of storage media. Disks are provided herein as only one example.

Although examples of clusters have been provided herein, many variations exist without departing from the spirit of the present invention. For example, different networks can be used, including less reliable networks, since faults are tolerated. Many other variations also exist.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of managing clusters of a communications environment, said method comprising:
obtaining a cluster of nodes, said cluster of nodes comprising one or more nodes of a data owning cluster; and
dynamically joining the cluster of nodes by one or more other nodes to access data owned by the data owning cluster.

2. The method of claim 1, wherein the cluster of nodes is an active cluster, said active cluster comprising at least a portion of the data owning cluster, said at least a portion of the data owning cluster including the one or more nodes, and said active cluster comprising at least a portion of a data using cluster, said at least a portion of the data using cluster including the one or more other nodes that dynamically joined the active cluster.

3. The method of claim 1, wherein the dynamically joining is in response to a request by at least one node of the one or more other nodes to access data of the data owning cluster.

4. The method of claim 1, wherein the data is maintained in one or more file systems owned by the data owning cluster.

5. The method of claim 1, further comprising:
requesting, by at least one node of the one or more other nodes that dynamically joined the cluster of nodes, access to data owned by the data owning cluster; and
mounting a file system having the data on the at least one node requesting access.

6. The method of claim 5, wherein the mounting comprises performing one or more tasks, by the at least one node requesting access, to obtain data from a file system manager of the file system to mount the file system.

7. The method of claim 1, further comprising checking authorization of a user of at least one node of the one or more other nodes prior to allowing the user to access data owned by the data owning cluster.

8. The method of claim 1, wherein a node of the one or more other nodes dynamically joins the cluster of nodes to perform a particular task.

9. The method of claim 8, wherein the node leaves the cluster of nodes subsequent to performing the particular task.

10. The method of claim 1, further comprising dynamically joining by at least one node of the one or more other nodes another cluster of nodes to access data owned by another data owning cluster.

11. The method of claim 1, further comprising dynamically joining the cluster of nodes by at least another node.

12. The method of claim 1, further comprising processing a request, by a node of the one or more other nodes, to access data owned by the data owning cluster, wherein said processing comprises translating an identifier of a user of the request to an identifier associated with the data owning cluster to determine whether the user is authorized to access the data.

13. The method of claim 12, further comprising checking security credentials of the user to determine whether the user is authorized to access the data.

14. The method of claim 1, wherein the one or more other nodes comprise at least a portion of a data using cluster, and wherein the method further comprises configuring at least one node of the data using cluster for access to the data.

15. The method of claim 1, further comprising configuring the data owning cluster to enable access by at least one node of the one or more other nodes.

16. The method of claim 1, wherein the data is stored on one or more storage media of the data owning cluster, and wherein access to the data is controlled via one or more leases of the one or more storage media.

17. A system of managing clusters of a communications environment, said system comprising:
means for obtaining a cluster of nodes, said cluster of nodes comprising one or more nodes of a data owning cluster; and
means for dynamically joining the cluster of nodes by one or more other nodes to access data owned by the data owning cluster.

18. The system of claim 17, wherein the dynamically joining is in response to a request by at least one node of the one or more other nodes to access data of the data owning cluster.

19. The system of claim 17, wherein the data is maintained in one or more file systems owned by the data owning cluster.

20. The system of claim 17, further comprising:
means for requesting, by at least one node of the one or more other nodes that dynamically joined the cluster of nodes, access to data owned by the data owning cluster; and
means for mounting a file system having the data on the at least one node requesting access.

21. The system of claim 17, wherein a node of the one or more other nodes dynamically joins the cluster of nodes to perform a particular task.

22. The system of claim 21, wherein the node leaves the cluster of nodes subsequent to performing the particular task.

23. The system of claim 17, further comprising means for processing a request, by a node of the one or more other nodes, to access data owned by the data owning cluster, wherein said means for processing comprises means for translating an identifier of a user of the request to an identifier associated with the data owning cluster to determine whether the user is authorized to access the data.

24. A system of managing clusters of a communications environment, said system comprising:
a cluster of nodes, said cluster of nodes comprising one or more nodes of a data owning cluster; and
one or more other nodes to dynamically join the cluster of nodes to access data owned by the data owning cluster.

25. An article of manufacture comprising
at least one computer usable medium having computer readable program code logic to manage clusters of a communications environment, the computer readable program code logic comprising:
obtain logic to obtain a cluster of nodes, said cluster of nodes comprising one or more nodes of a data owning cluster; and
join logic to dynamically join the cluster of nodes by one or more other nodes to access data owned by the data owning cluster.

26. The article of manufacture of claim 25, wherein the dynamically joining is in response to a request by at least one node of the one or more other nodes to access data of the data owning cluster.

27. The article of manufacture of claim 25, wherein the data is maintained in one or more file systems owned by the data owning cluster.

28. The article of manufacture of claim 25, further comprising:
request logic to request, by at least one node of the one or more other nodes that dynamically joined the cluster of nodes, access to data owned by the data owning cluster; and
mount logic to mount a file system having the data on the at least one node requesting access.

29. The article of manufacture of claim 25, wherein a node of the one or more other nodes dynamically joins the cluster of nodes to perform a particular task.

30. The article of manufacture of claim 29, wherein the node leaves the cluster of nodes subsequent to performing the particular task.
